(19) United States
(12) Patent Application Publication
(10) Pub. No.: US 2004/0172289 A1
(43) Pub. Date: Sep. 2, 2004

(54) Method and system for remotely verifying a prescription

(76) Inventors: Dejan Kozic, Wadsworth, IL (US); Karl E. Meehan, Grayslake, IL (US); Dianne Isley, Northbrook, IL (US); Li Ding, Buffalo Grove, IL (US); Mike Simko, Palos Heights, IL (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/376,177

(22) Filed: Feb. 28, 2003

(51) Int. Cl. G06F 17/60

(52) U.S. Cl. 705/2

(57) ABSTRACT

A method and a system for remotely verifying a prescription are described herein. In particular, a first site may provide prescription information based on a prescription of a patient to a second site. The prescription information is inputted by a staff member at the first site. The second site is remotely located from the first site and operatively coupled to the first site. The first site may also provide a prescription image based on the prescription so that a pharmacist at the second site may review and compare the prescription information and the prescription image. Further, the first site may provide medical information associated with the patient to the second site so that the pharmacist at the second site may review and determine a condition suggesting a potential for an adverse effect on the patient by the drugs based on the medical information.

### TECHNICAL FIELD

The present disclosure relates to pharmaceutical services, and more particularly, to a method and a system for remotely verifying a prescription.

### BACKGROUND

The duty of a pharmacist has many facets including preparing and dispensing medicine, consulting customers, and verifying prescriptions. When a customer with a prescription comes into a pharmacy to place a new prescription order, for example, information on the prescription is entered into a computer of the pharmacy (i.e., by a staff member) to begin processing of that prescription order. The pharmacist needs to verify that information entered into the computer is complete and accurate according to the prescription before being dispensed so that proper information may be printed on prescription labels. In addition to verifying that information is entered correctly to fill the prescription, the pharmacist also needs to verify that the prescription does not conflict with any allergies, other medications, and health conditions of the patient to cause any harmful effect. For example, the pharmacist needs to verify that the patient is not allergic to the prescribed drugs. In another example, the pharmacist needs to verify that the prescribed drugs do not conflict with other medications currently being taken by the patient.

In addition to inputting information from the prescription into the computer, the staff member may fill the prescription order. As a result, the pharmacist needs to verify that the prescription is filled correctly before dispensing the product to the customer. For example, the pharmacist needs to verify that the proper type, dosage, and warnings of the prescribed drugs are provided to the customer.

As described above, a bottleneck may occur because of the number of verifications involved in processing prescriptions. Typically in a pharmacy, a pharmacist is available to provide such pharmaceutical services during normal business hours. Some pharmacies may have two pharmacists overlap during peak hours. In fact, some pharmacies may have two or more pharmacists on duty at any time during normal business hours regardless of peak hours. However, peak hours may vary from pharmacy to pharmacy, and employing multiple pharmacists at all locations may not be cost effective and feasible. As a result, a pharmacist may be overloaded with the task of verifying prescriptions especially during peak hours.

Therefore, a need exists to optimize resources to provide better customer service.

### BRIEF DESCRIPTION OF THE DRAWINGS

This disclosure will describe several embodiments to illustrate its broad teachings. Reference is also made to the attached drawings.

FIG. 1 is a block diagram representation of a system for remotely verifying a prescription.

FIG. 2 is a block diagram representation of a host site.

FIG. 3 is a flow diagram illustrating a method for remotely verifying a prescription.

### DETAILED DESCRIPTION

A method and a system for remotely verifying a prescription are described. In particular, a first site (e.g., a pharmacy) may provide prescription information based on a prescription of a patient to a second site (e.g., another pharmacy). The second site is remotely located from the first site but operatively coupled to the first site. For example, the first and second sites may be pharmacies in different parts of the same city, in different cities, or even in different states. The second site may also be a home of a telecommuting pharmacist or a facility with a plurality of pharmacists to verify prescriptions as described in detail below. The prescription information such as, but not limited to, information associated with the patient, the prescriber (e.g., a physician or a nurse), and the prescribed drugs are inputted by a staff member (e.g., a technician) at the first site. For example, the prescription information may include name, address, and phone number of the patient and the prescriber. The prescription information may also include type and dosage of the prescribed drugs.

In addition to providing the prescription information to the second site, the first site may provide a prescription image based on the prescription so that a pharmacist at the second site may review and compare the prescription information and the prescription image. For example, the staff member at the first site may scan a hard copy of the prescription to generate a visual display of the hard copy, which in turn, may be viewed by the pharmacist at the second site. As noted above, the prescription information may be inputted by the staff member at the first site (e.g., the staff member may manually input the prescription information with a keyboard or the staff member may transfer the prescription information from a data storage device such as a smartcard or a memory stick). Based on the prescription image, the pharmacist at the second site may verify that the prescription information is complete and accurate.

Further, the first site may provide medical information associated with the patient to the second site so that the pharmacist at the second site may review and determine a condition suggesting a potential for an adverse effect on the patient by the drugs based on the medical information. For example, the medical information may include, but is not limited to, an allergy, a health condition, and a current medication of the patient. Based on the medical information, the pharmacist at the second site may verify that the prescribed drugs do not conflict with, if any, an allergy, a health condition, and a current medication of the patient. Accordingly, the pharmacist at the second site may reduce the workload of the pharmacist at the first site by assisting with the verifications involved in processing prescriptions. As a result, the pharmacist at the first site may have more time for other tasks such as consulting customers.

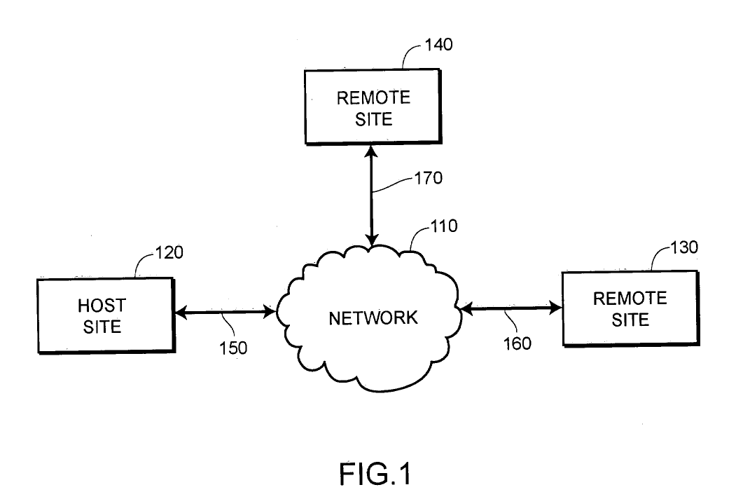

Referring to FIG. 1, a system 100 for remotely verifying a prescription of a patient for drugs includes a network 110, a host site 120, and remote sites, generally shown as 130 and 140. The host site 120 may be, but is not limited to, a first pharmacy configured to process the prescription. Typically, a customer may bring a hard copy of the prescription to the host site 120 for a pharmacy staff member or a pharmacist to fill the prescription but the prescription may be called in by the patient's care provider. The remote sites 130, 140 are operatively coupled to and remotely located from the host site 110. For example, the remote site 130 may be a pharmacy located in a different part of the same city, in a different city, or even in a different state than the host site 120. As described in further detail below, a pharmacist at the remote site 130 may assist a pharmacist at the host site 120 to verify the prescription. Persons of ordinarily skill in the art will readily appreciate that if host site 120 and the remote site 130 are in different states, the pharmacist at the remote site 130 may need to be registered to practice pharmacy in the state of the host site 120 in accordance with the laws of that state. In another example, the remote site 140 may be a home of a telecommuting pharmacist or a facility with a plurality of pharmacists on duty to perform pharmaceutical services including verifying prescriptions.

The host site 120 and the remote sites 130,140 may be operatively coupled to the network 110 via links, generally shown as 150, 160, and 170, respectively, so that information may be exchanged between the sites. For example, the host site 120 and the remote sites 130, 140 may be operatively coupled to the network 110 via an Internet connection, e.g., a T-1 connection, an Integrated Services Digital Network (ISDN) connection, and a Voice over Internet Protocol (VoIP) connection. The links 150, 160, 170 may be, but are not limited to, wireless links (e.g., satellite), wired links (e.g., plain ordinary telephone (POT) lines), or a combination of wireless links and wired links.

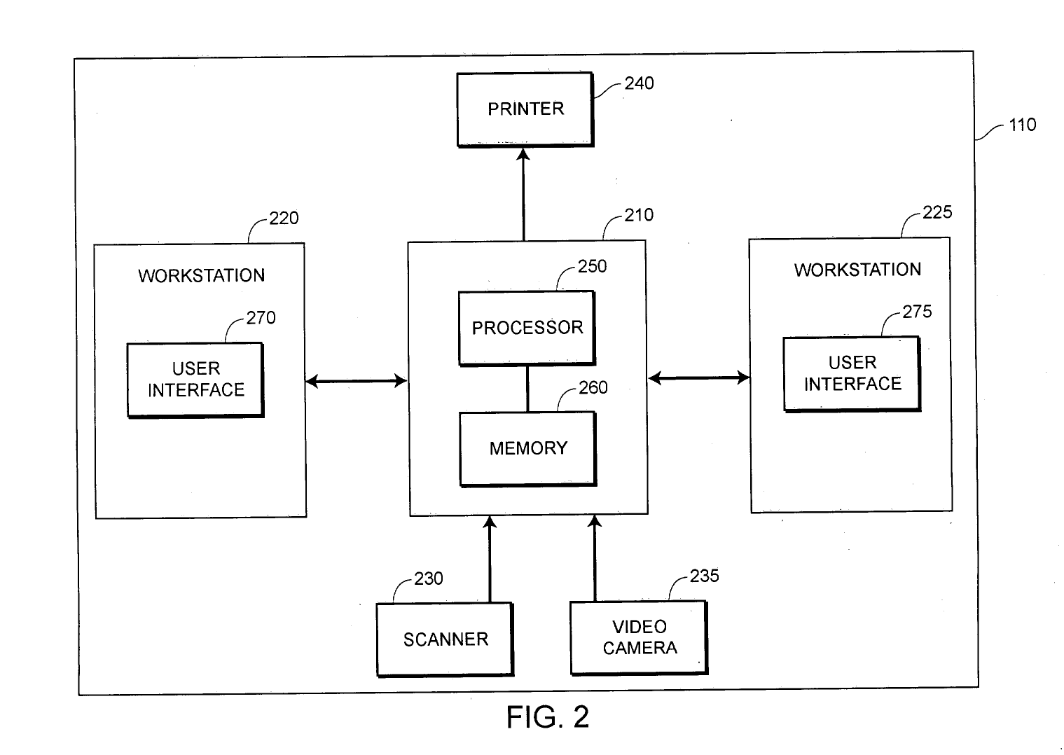

Referring to FIG. 2, the host site 120 generally includes a controller 210, a workstation (generally shown as 220 and 225), a scanner 230, a video camera 235, and a printer 240. The controller 210 includes a processor 250 and a memory 260. The processor 250 is operatively coupled to the memory 260, which stores a program or a set of operating instructions for the processor 250. The processor 250 executes the program or the set of operating instructions such that the host site 120 operates as described herein. The program or the set of operating instructions may be embodied in a computer-readable medium such as, but not limited to, paper, a programmable gate array, an application specific integrated circuit (ASIC), an erasable programmable read only memory (EPROM), a read only memory (ROM), a random access memory (RAM), a magnetic media, and an optical media.

The workstations 220, 225 are operatively coupled to the controller 210. Each workstation 220 and 225 has associated therewith a user interface, generally shown as 270 and 275, respectively. The user interface 270, 275 may include, but is not limited to, a touch-sensitive display, a monitor, a keyboard, and/or a mouse. The scanner 230, the video camera 235, and the printer 240 are operatively coupled to the controller 210 so that the workstations 220, 225 may share such peripherals. In particular, the scanner 230 or the video camera 235 may be configured to generate a prescription image based on a hard copy of the prescription. The prescription image may be viewed by the pharmacy staff member and/or the pharmacist at one of the workstations 220, 225 (i.e., via the user interface 270, 275). The printer 240 may be configured to generate prescription labels for the prescription. Although the workstations 220, 225, the scanner 230, the video camera 235, and the printer 240 are shown as separate components, persons of ordinary skill will appreciate that a scanner, a video camera, and a printer may be integrated into as parts of each of the workstations 220, 225.

As noted above, the duty of a pharmacist includes verifying the prescription. The verification task primarily involves three stages: (1) a data review, (2) a issue review, and (3) a product review. In particular, the data review involves verifying that prescription information inputted by a staff member at a pharmacy is complete and accurate. For example, the staff member may manually input the prescription information from a hard copy of the prescription via a keyboard, a mouse, and/or a touch-sensitive display. In another example, the staff member may input the prescription information by transferring data from a patient's data storage device such as a smartcard or a memory stick. To ensure the safety of the patient, the pharmacist may verify that the prescribed drugs do not interact adversely with, for example, an allergy, a health condition, or a current medication of the patient during the issue review. Lastly, the pharmacist may verify that the prescription is filled properly (i.e., proper type and dosage of drugs is provided to the patient). The data review and the issue review may be completed by a pharmacist remotely located from the pharmacy.

To illustrate the concept of remotely verifying a prescription with the system 100 shown in FIGS. 1 and 2, a basic flow for remotely verifying a prescription may start with a staff member (or a technician) at the host site 120 physically receiving a hard copy of a new prescription from a customer (and/or a patient) or via facsimile or other electronic methods. The staff member at the host site 120 may input prescription information from the hard copy of the prescription into the controller 210 via the user interface 270 at the workstation 220. Similarly, the staff member at the host site 120 may input the prescription information into the controller 210 via the user interface 275 at the workstation 225. As noted above, for example, the staff member may either manually input the prescription information from a hard copy of the prescription via a keyboard, a mouse, and/or a touch-sensitive display or input the prescription information by transferring data from a patient's data storage device such as a smartcard or a memory stick. The prescription information inputted by the pharmacy staff member may include information associated with, but not limited to, the patient, the prescriber (i.e., a physician or a nurse), and the drug of the prescription. That is, the prescription information may include name, address, and phone number of the patient and the prescriber, and type, quantity, and number of refills of the prescribed drugs. Persons of ordinary skill in the art will readily recognize that the prescription information may be used to generate prescription labels via the printer 240 to identify the prescription.

Upon inputting the prescription information into the controller 210, the staff member at the host site 120 may generate a prescription image of the prescription. That is, the staff member may scan the hard copy of the prescription into the controller 210 via the scanner 230 or the video camera 235. Accordingly, the prescription image and the prescription information may be transmitted to a pharmacist at a remote site (one shown as 130). As noted above, a part of a pharmacist's duty is to verify that the prescription information is entered correctly. Especially during peak hours, for example, the pharmacist at the host site 120 may need assistance to process all the prescriptions received at the host site 120. To provide better customer service at the host site 120, the workload of the pharmacist at the host site 120 needs to be reduced to allow more time for the pharmacist to consult with customers. Thus, the pharmacist at the remote site 130 may assist the pharmacist at the host site 120 by reviewing and comparing the prescription image and the prescription information, and verifying that the prescription information is correct (i.e., the information entered into the controller 210 is the same information on the hard copy of the prescription). Alternatively, a physician or a nurse may provide an electronic copy of the prescription to the host site 120 via an e-mail or the Internet. The electronic copy of the prescription may be used as the prescription image to be transmitted to the pharmacist at the remote site 130 for review and comparison with the prescription information.

To ensure safety of the patient, the staff member and/or the pharmacist at the host site 120 may inquire for medical information of the patient. The medical information may include, but is not limited to, allergies, current medication (e.g., vitamins, supplements, herbals, over-the-counter drugs, or other prescribed drugs), and health condition of the patient. The pharmacist at the remote site 130 may further assist the pharmacist at the host site 120 by verifying that the patient of the prescription may consume the prescribed drugs without adverse effect to the patient. That is, the pharmacist at the remote site 130 may be provided with medical information associated with the patient by the host site 120. For example, the host site 120 may directly provide the remote site 130 with medical information associated with the patient. In another example, the host site 120 may inquire a central location (e.g., a central server at the network 110) to retrieve medical information associated with the patient from a database (not shown). Accordingly, the central location may either directly forward the medical information associated with the patient to remote site 130 or forward the medical information to the host site 120, which in turn, may then forward the medical information to the remote site 130.

Upon receiving the medical information, the pharmacist at the remote site 130 may compare the prescribed drugs with the medical information associated with the patient, and determine whether a condition suggesting a potential for an interaction exists. For example, the pharmacist at the remote site 130 may determine whether the patient is allergic to the prescribed drugs. In another example, the pharmacist at the remote site 130 may determine whether the prescribed drugs and the current medication of the patient may interact adversely to the patient.

To complete processing of the prescription, the staff member at the host site 120 may fill the prescription, and the pharmacist at the host site 120 may conduct the product review to ensure that proper type and dosage is given to the patient. As a result, pharmacists at different locations may assist each other without physically being at a particular location.

Alternatively, the controller 210 at the host site 120 may provide and store the prescription information, the prescription image, and if any, the medical information in a queue (not shown) at the network 110. Here, pharmacists at remote sites 130, 140 may retrieve to verify prescriptions in accordance to the queue. That is, the queue may receive prescriptions that need to be verified from pharmacies such as the host site 120. Based on either a chronological order that the prescriptions are received by the queue or a priority order that the prescriptions need to be delivered, the pharmacists at the remote sites 130, 140 may retrieve to verify the prescriptions.

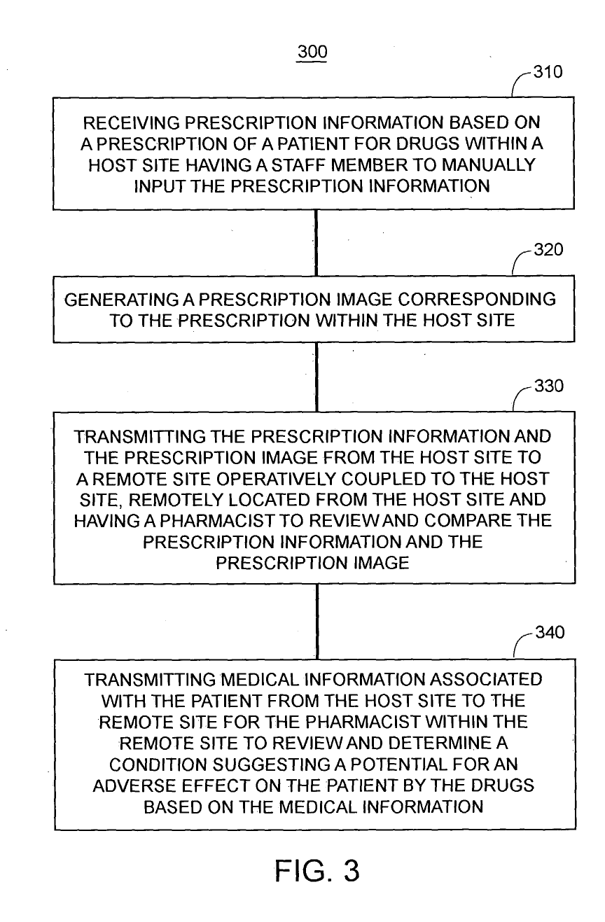

One possible implementation of the computer program executed by the controller 210 (e.g., via the processor 250) is illustrated in FIG. 3. Persons of ordinary skill in the art will appreciate that the computer program can be implemented in any of many different ways utilizing any of many different programming codes stored on any of many computer-readable mediums such as a volatile or nonvolatile memory or other mass storage device (e.g., a floppy disk, a compact disc (CD), and a digital versatile disc (DVD)). Thus, although a particular order of steps is illustrated in FIG. 3, persons of ordinary skill in the art will appreciate that these steps can be performed in other temporal sequences. Again, the flow chart 300 is merely provided as an example of one way to program the controller 210. The flow chart 300 begins at step 310, wherein the controller 210 receives prescription information based on a prescription of a patient for drugs within a host site (e.g., a pharmacy). The host site includes a staff member to input the prescription information into the controller 210. The prescription information may include information such as, but not limited to name, address, and phone number of the patient and the prescriber, and type and dosage of the prescribed drugs. At step 320, the controller 210 may generate a prescription image corresponding to the prescription within the host site. For example, the staff member may scan a hard copy of the prescription to provide an electronic copy of the prescription (i.e., the prescription image). Upon generating the prescription image, the controller 210 at step 330 may transmit the prescription information and the prescription image from the host site to a remote site (e.g., another pharmacy). The remote site is remotely located from the host site but the second site has a pharmacist to perform pharmaceutical services such as verifying prescriptions. In particular, the pharmacist at the remote site may review and compare the prescription information and the prescription image to verify that the staff member at the host site correctly entered the prescription information from the hard copy of the prescription into the controller 210.

Further, the controller 210 at step 340 may transmit medical information associated with the patient from the first site to the second site for the pharmacist at the second site to review and determine a condition suggesting a potential for an adverse effect on the patient by the drugs based on the medical information. The medical information may include, but is not limited to, information associated with one of an allergy, a health condition, and/or a current medication of the patient. For example, the pharmacist at the second site may verify that the patient is not allergic to the prescribed drugs and/or the current medication taken by the patient does not interact adversely with the prescribed drugs. As a result, the pharmacist at the remote site may assist the pharmacist at the host site with the task of verifying prescriptions received at the host site, which in turn, mitigates the bottle-neck and increases efficiency in processing those prescriptions.

Although much of the above discussion has focused on verifying a prescription, persons of ordinary skill in the art will appreciate that the teachings herein are in no way limited to such task of a pharmacist. Persons of ordinary skill in the art will readily appreciate that the teachings of this disclosure can be employed with other pharmaceutical services.

Many changes and modifications to the embodiments described herein could be made. The scope of some changes is discussed above. The scope of others will become apparent from the appended claims.

What is claimed is:

1. A method for remotely verifying a prescription, the method comprising:
providing prescription information based on a prescription of a patient for drugs from a first site to a second site, the prescription information being inputted by a staff member at the first site, and the second site being remotely located from the first site and operatively coupled to the first site;
providing a prescription image based on the prescription from the first site to the second site for a pharmacist at the second site to review and compare the prescription information and the prescription image; and
providing medical information associated with the patient from the first site to the second site for the pharmacist at the second site to review and determine a condition suggesting a potential for an adverse effect on the patient by the drugs based on the medical information.

2. The method of claim 1, wherein the step of providing prescription information based on a prescription of a patient for drugs from a first site to a second site comprises providing information associated with one of the patient, the prescriber of the drugs, and the prescribed drugs from the first site to the second site.

3. The method of claim 1, wherein the step of providing prescription information based on a prescription of a patient for drugs from a first site to a second site comprises providing prescription information based on a prescription of a patient for drugs from a first pharmacy to one of a second pharmacy, a facility having a plurality of pharmacists, and a home of a telecommuting pharmacist.

4. The method of claim 1, wherein the step of providing a prescription image based on the prescription from the first site to the second site for a pharmacist at the second site to compare the prescription information and the prescription image comprises:
scanning a hard copy of the prescription within the first site;
generating an image of the hard copy of the prescription within the first site; and
transmitting the image from the first site to the second site.

5. The method of claim 1, wherein the step of providing medical information associated with the patient from the first site to the second site for the pharmacist at the second site to review and determine a condition suggesting a potential for an adverse effect on the patient by the drugs based on the medical information comprises providing information associated with one of an allergy, a health condition, and a current medication of the patient from the first site to the second site.

6. A method for verifying a prescription, the method comprising:
receiving prescription information based on a prescription of a patient for drugs within a host site, the host site having a staff member to input the prescription information;
generating a prescription image corresponding to the prescription within the host site;
transmitting the prescription information and the prescription image from the host site to a remote site operatively coupled to the host site, the remote site being remotely located from the host site and having a pharmacist to review and compare the prescription information and the prescription image; and
transmitting medical information associated with the patient from the host site to the remote site for the pharmacist at the remote site to review and determine a condition suggesting a potential for an adverse effect on the patient by the drugs based on the medical information.

7. The method of claim 6, wherein the step of receiving prescription information based on a prescription of a patient for drugs within a host site comprises receiving information associated with one of the patient, the prescriber of the drugs, and the prescribed drugs within the host site.

8. The method of claim 6, wherein the step of generating a prescription image based on the prescription within the host site comprises scanning a hard copy of the prescription within the host site.

9. The method of claim 6, wherein the step of transmitting the prescription information and the prescription image from the host site to a remote site operatively coupled to the host site comprises transmitting the prescription information and the prescription image from a first pharmacy to a second pharmacy operatively coupled to the first pharmacy.

10. The method of claim 6, wherein the step of transmitting medical information associated with the patient from the host site to the remote site for the pharmacist at the remote site to review and determine a condition suggesting a potential for an adverse effect on the patient by the drugs based on the medical information comprises transmitting information associated with one of an allergy, a health condition, and a current medication of the patient from the host site to the remote site.

11. A system for remotely verifying a prescription, the system comprising:
a first site having a staff member to input prescription information based on a prescription of a patient for drugs into a controller; and
a second site remotely located from the first site and operatively coupled to the first site, the second site having a pharmacist to review and compare the prescription information and a prescription image and to determine a condition suggesting a potential for an adverse effect on the patient by the drugs based on medical information associated with the patient,
wherein the controller is configured to generate the prescription image based on the prescription and to transmit the prescription information, the prescription image, and the medical information from the first site to the second site.

12. The system of claim 11, wherein the first site is a pharmacy.

13. The system of claim 11, wherein the second site is one of a pharmacy, a facility having a plurality of pharmacists, and a home of a telecommuting pharmacist.

14. The system of claim 11, wherein the prescription information is information associated with one of the patient, the prescriber of the drugs, and the prescribed drugs.

15. The system of claim 1, wherein the medical information is information associated with one of an allergy, a health condition, and a current medication of the patient.

16. In a prescription processing system, a processor operates in accordance with a computer program embodied on a computer-readable medium for remotely verifying a prescription, the computer program comprising:
a first routine that directs the processor to provide prescription information based on a prescription of a patient for drugs from a first site to a second site, the prescription information being inputted by a staff member at the first site, and the second site being remotely located from the first site and operatively coupled to the first site;
a second routine that directs the processor to provide a prescription image based on the prescription from the first site to the second site for a pharmacist at the second site to review and compare the prescription information and the prescription image; and
a third routine that directs the processor to provide medical information associated with the patient from the first site to the second site for the pharmacist at the second site to review and determine a condition suggesting a potential for an adverse effect on the patient by the drugs based on the medical information.

17. The computer program of claim 16, wherein the first routine comprises a routine that directs the processor to provide information associated with one of the patient, the prescriber of the drugs, and the prescribed drugs from the first site to the second site.

18. The computer program of claim 16, wherein the first routine comprises a routine that directs the processor to provide prescription information based on a prescription of a patient for drugs from a first pharmacy to one of a second pharmacy, a facility having a plurality of pharmacists, and a home of a telecommuting pharmacist.

19. The computer program of claim 16, wherein the second routine comprises:
a routine that directs the processor to scan a hard copy of the prescription within the first site;
a routine that directs the processor to generate an image of the hard copy of the prescription within the first site; and
a routine that directs the processor to transmit the image from the first site to the second site.

20. The computer program of claim 16, wherein the third routine comprises a routine that directs the processor to provide information associated with one of an allergy, a health condition, and a current medication of the patient from the first site to the second site.

21. The computer program of claim 16, wherein the medium is one of paper, a programmable gate array, application specific integrated circuit, erasable programmable read only memory, read only memory, random access memory, magnetic media, and optical media.
